(19) United States
(12) Patent Application Publication
(10) Pub. No.: US 2015/0042265 A1
(43) Pub. Date: Feb. 12, 2015

(54) WIRELESS POWERING OF ELECTRONIC DEVICES

(71) Applicant: DvineWave Inc., San Ramon, CA (US)

(72) Inventors: Michael A. Leabman, San Ramon, CA (US); Gregory Scott Brewer, Livermore, CA (US)

(73) Assignee: DvineWave Inc., San Ramon, CA (US)

(21) Appl. No.: 13/960,522

(22) Filed: Aug. 6, 2013

(51) Int. Cl. H02J 7/02; H04B 5/00

(52) U.S. Cl. CPC H02J 7/025; H04B 5/0037
USPC 320/108

(57) ABSTRACT

The present invention describes a methodology for wireless power transmission based on pocket-forming. This methodology may include one transmitter and at least one or more receivers, being the transmitter the source of energy and the receiver the device that is desired to charge or power. Techniques for determining the location of devices including receivers may be disclosed.

### CROSS-REFERENCES TO RELATED APPLICATIONS

The present invention is related to U.S. Non-Provisional patent application Ser. No. 13/891,340 filed May 10, 2013, entitled Methodology for Pocket-Forming; U.S. Non-Provisional patent application Ser. No. 13/925,469 filed Jun. 24, 2013, entitled Methodology for Multiple Pocket-Forming; U.S. Non-Provisional patent application Ser. No. 13/946,082 filed Jul. 19, 2013, entitled Method for 3 Dimensional Pocket-Forming; U.S. Non-Provisional patent application Ser. No. 13/891,399, filed May 10, 2013, entitled Receivers for Wireless Power Transmission and U.S. Non-Provisional patent application Ser. No. 13/891,445, filed May 10, 2013, entitled Transmitters for Wireless Power Transmission, the entire content of which are incorporated herein by these references.

### FIELD OF INVENTION

The present invention relates generally to wireless power transmission, and more particularly, to wireless power transmission through pocket-forming.

### BACKGROUND OF THE INVENTION

Electronic devices such as laptop computers, smartphones, portable gaming devices, tablets and so forth may require power for performing their intended functions. This may require having to charge electronic equipment at least once a day, or in high-demand electronic devices more than once a day. Such an activity may be tedious and may represent a burden to users. For example, a user may be required to carry chargers in case his electronic equipment is lacking power. In addition, users have to find available power sources to connect to. Lastly, users must plugin to a wall or other power supply to be able to charge his or her electronic device. However, such an activity may render electronic devices inoperable during charging. Current solutions to this problem may include inductive pads which may employ magnetic induction or resonating coils. Nevertheless, such a solution may still require that electronic devices may have to he placed in a specific place for powering. Thus, electronic devices during charging may not be portable. For the foregoing reasons, there is a need for a wireless power transmission system where electronic devices may be powered without requiring extra chargers or plugs, and where the mobility and portability of electronic devices may not be compromised.

### SUMMARY OF THE INVENTION

The present invention describes a methodology for wireless power transmission based on pocket-forming. This methodology may include one transmitter and at least one or more receivers, being the transmitter the source of energy and the receiver the device that is desired to charge or power. Techniques for determining the location of devices including receivers may be disclosed.

In an embodiment, a description of pocket-forming methodology using at least one transmitter and at least one receiver may be provided.

In another embodiment, a transmitter suitable for pocket-forming including at least two antenna elements may he provided.

In a further embodiment, a receiver suitable for pocket forming including at least one antenna element may be provided.

In an embodiment, a transmitter including features for creating pockets of energy in its top surface may be provided.

In a further embodiment, a portable mat including at least one receiver and transmitter for re-transmitting pockets of energy from a transmitter to other devices may be provided.

In yet another embodiment, a wireless power transmission including a tracer which may serve for establishing desired locations for the generation of pockets of energy over at least one receiving device may be provided.

In an even further embodiment, a wireless power transmission including a tracer which may serve for establishing desired locations for the generation of pockets of energy over a plurality of receiving devices may be provided.

A method for wireless powering of an electronic device comprises the steps of transmitting controlled radio frequency waves from a pocket-forming transmitter to converge pockets of energy in 3-d space; and capturing the pockets of energy in a receiver to charge or power the electronic device connected to the receiver or in the immediate vicinity of the receiver.

### BRIEF DESCRIPTION OF THE DRAWINGS

Embodiments of the present invention are described by way of example with reference to the accompanying figures which are schematic and may not be drawn to scale, Unless indicated as representing the background information, the figures represent aspects of the present invention.

FIG. 1 illustrates wireless power transmission using pocket-forming, according to an embodiment of the present invention.

FIG. 2 illustrates a component level illustration for a transmitter which may be utilized to provide wireless power transmission as described in FIG. 1.

FIG. 3 illustrates a component level embodiment for a receiver which can be used for powering or charging an electronic device as described in FIG. 1.

FIG. 4 illustrates a wireless power transmission (WPT) where a transmitter (similar to transmitter described in FIG. 2) may include a button which upon activation may create at least one pocket of energy in its top surface according to the invention of FIG. 1.

FIG. 5 illustrates an alternative configuration to WPT, described in FIG. 4 above, in the form of a wireless power transmission where a transmitter may create at least one pocket of energy on a portable mat which may further re-direct power to other receiving devices according to the present invention.

FIG. 6 includes FIG. 6A and FIG. 6B which depict a wireless power transmission including a tracer which may serve for establishing desired locations for the generation of pockets of energy over at least one receiving device to the present invention.

FIG. 7 illustrates a wireless power transmission including a tracer which may serve for establishing desired locations for the generation of pockets of energy over a plurality of receiving devices according to the present invention.

### DETAILED DESCRIPTION OF THE DRAWINGS

### Definitions

“Pocket-forming” may refer to generating two or more RF waves which converge in 3-d space, forming controlled constructive and destructive interference patterns.

“Pockets of energy” may refer to areas or regions of space where energy or power may accumulate in the form of constructive interference patterns of RF waves.

“Null-space” may refer to areas or regions of space where pockets of energy do not form because of destructive interference patterns of RF waves.

“Transmitter” may refer to a device, including a chip which may generate two or more RF signals, at least one RF signal being phase shifted and gain adjusted with respect to other RF signals, substantially all of which pass through one or more RF antenna such that focused RF signals are directed to a target.

“Receiver” may refer to a device including at least one antenna element, at least one rectifying circuit and at least one power converter, which may utilize pockets of energy for powering, or charging an electronic device.

“Adaptive pocket-forming” may refer to dynamically adjusting pocket forming to regulate power on one or more targeted receivers.

### DESCRIPTION OF THE DRAWINGS

In the following detailed description, reference is made to the accompanying drawings, which form a part hereof. In the drawings, which may not be to scale or to proportion, similar symbols typically identify similar components, unless context dictates otherwise. The illustrative embodiments described in the detailed description, drawings and claims, are not meant to be limiting. Other embodiments can be used and/or and other changes can be made without departing from the spirit or scope of the present invention.

A. Essentials of Pocket-Forming

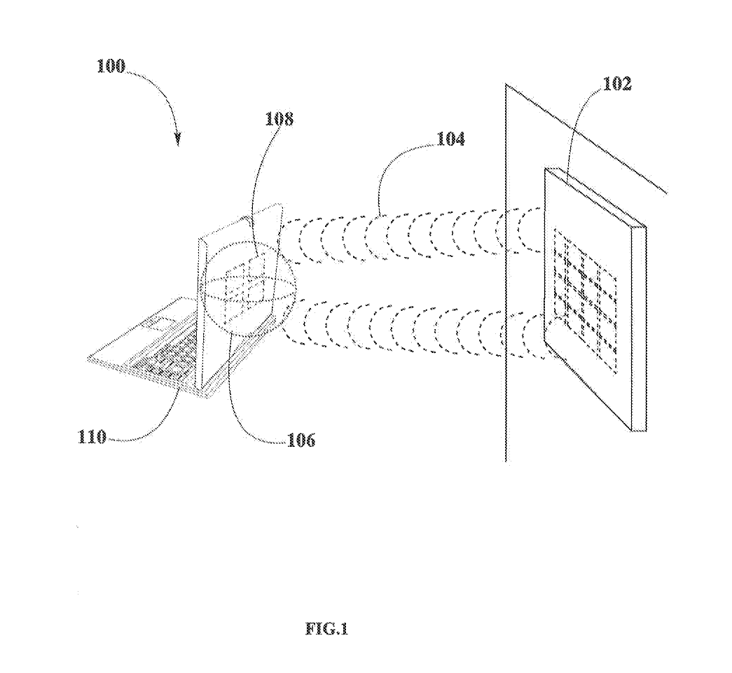

FIG. 1 illustrates wireless power transmission (WPT) 100 using pocket-forming. A transmitter 102 may transmit controlled Radio Frequency (RF) waves 104 which may converge in 3-d space. These waves 104 may be controlled through phase and/or relative amplitude adjustments to form constructive and destructive interference patterns (pocket-forming). Pockets of energy 106 may form at constructive interference patterns and can be 3-dimensional in shape whereas null-spaces may be generated at destructive interference patterns. A receiver 108 may then utilize pockets of energy 106 produced by pocket-forming for charging or powering an electronic device, for example a laptop computer 110 and thus effectively providing wireless power transmission. In some embodiments, there can be multiple transmitters 102 and/or multiple receivers 108 for powering various electronic devices, for example smartphones, tablets, music players, toys and others at the same time. In other embodiments, adaptive pocket-forming may be used to regulate power on electronic devices.

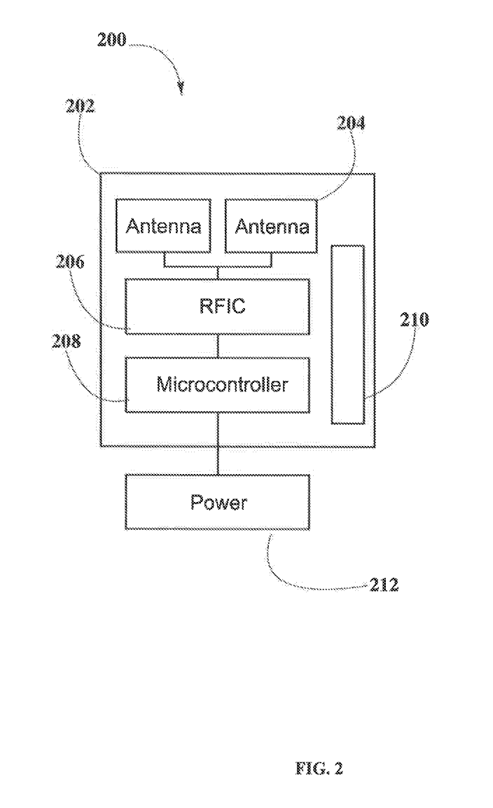

FIG. 2 illustrates a component level embodiment for a transmitter 200 which may be utilized to provide wireless power transmission 100 as described in FIG. 1. Transmitter 200 may include a housing 202 where at least two or more antenna elements 204, at least one RF integrated circuit (RFIC) 206, at least one digital signal processor (DSP) or micro-controller 208, and one optional communications component 210 may be included. Housing 202 can be made of any suitable material which may allow for signal or wave transmission and/or reception, for example plastic or hard rubber. Antenna elements 204 may include suitable antenna types for operating in frequency bands such as 900 MHz, 2.5 GHz or 5.8 GHz as these frequency bands conform to Federal Communications Commission (FCC) regulations part 18 (Industrial, Scientific and Medical equipment). Antenna elements 204 may include vertical or horizontal polarization, right hand or left hand polarization, elliptical polarization, or other suitable polarizations as well as suitable polarization combinations. Suitable antenna types may include, for example, patch antennas with heights from about ⅛ inches to about 6 inch and widths from about ⅛ inches to about 6 inch. Other antenna elements 204 types can be used, for example meta-materials, dipole antennas among others. RFIC 206 may include a proprietary chip for adjusting phases and/or relative magnitudes of RF signals which may serve as inputs for antenna elements 204 for controlling pocket-forming. These RF signals may be produced using an external power supply 212 and a local oscillator chip (not shown) using a suitable piezoelectric material. Micro-controller 208 may then process information send by a receiver through its own antenna elements for determining optimum times and locations for pocket-forming. In some embodiments, the foregoing may be achieved through communications component 210. Communications component 210 may be based on standard wireless communication protocols which may include Bluetooth, Wi-Fi or ZigBee. In addition, communications component 210 may be used to transfer other information such as an identifier for the device or user, battery level, location or other such information. Other communications component 210 may be possible which may include radar, infrared cameras or sound devices for sonic triangulation for determining the device's position.

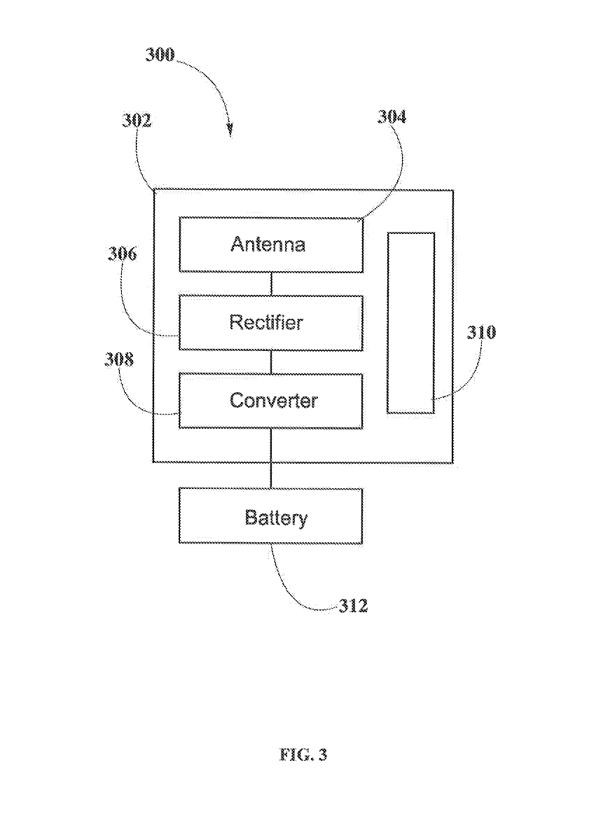

FIG. 3 illustrates a component level embodiment for a receiver 300 which can be used for powering or charging an electronic device as exemplified in wireless power transmission 100. Receiver 300 may include a housing 302 where at least one antenna element 304, one rectifier 306, one power converter 308 and an optional communications component 310 may be included. Housing 302 can be made of any suitable material which may allow for signal or wave transmission and/or reception, for example plastic or hard rubber. Housing 302 may be an external hardware that may be added to different electronic equipment, for example in the form of cases, or can be embedded within electronic equipment as well. Antenna element 304 may include suitable antenna types for operating in frequency bands similar to the bands described for transmitter 200 from FIG. 2. Antenna element 304 may include vertical or horizontal polarization, right hand or left hand polarization, elliptical polarization, or other suitable polarizations as well as suitable polarization combinations. Using multiple polarizations can be beneficial in devices where there may not be a preferred orientation during usage or whose orientation may vary continuously through time, for example a smartphone or portable gaming system. On the contrary, for devices with well-defined orientations, for example a two-handed video game controller, there might be a preferred polarization for antennas which may dictate a ratio for the number of antennas of a given polarization. Suitable antenna types may include patch antennas with heights from about ⅛ inches to about 6 inch and widths from about ⅛ inches to about 6 inch. Patch antennas may have the advantage that polarization may depend on connectivity, i.e. depending on which side the patch is fed, the polarization may change. This may further prove advantageous as a receiver, such as receiver 300, may dynamically modify its antenna polarization to optimize wireless power transmission. Rectifier 306 may include diodes or resistors, inductors or capacitors to rectify the alternating current (AC) voltage generated by antenna element 304 to direct current (DC) voltage. Rectifier 306 may be placed as close as is technically possible to antenna element 304 to minimize losses. After rectifying AC voltage, DC voltage may be regulated using power converter 308. Power converter 308 can be a DC-DC converter which may help provide a constant voltage output, regardless of input, to an electronic device, or as in this embodiment to a battery 312. Typical voltage outputs can be from about 5 volts to about 10 volts. Lastly, communications component 310, similar to that of transmitter 200 from FIG. 2, may be included in receiver 300 to communicate with a transmitter or to other electronic equipment.

B. Wireless Power Transmission for Devices

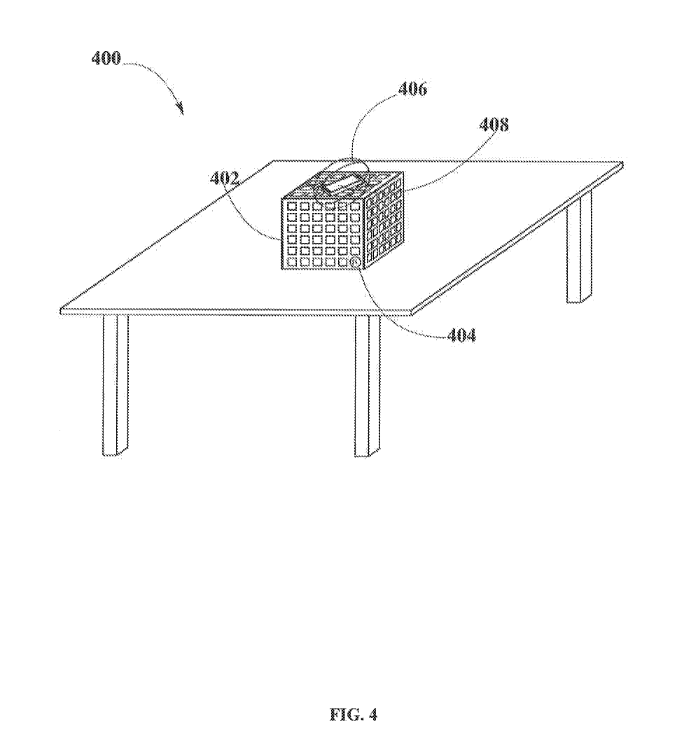

FIG. 4 illustrates a wireless power transmission 400 where a transmitter 402 (similar to transmitter 200 described in FIG. 2) may include a button 404 which upon activation may create at least one pocket of energy 406 in its top surface. A smartphone 408 operatively coupled to a receiver (not shown), upon being placed atop such surface, may receive power wirelessly by utilizing the aforementioned pocket of energy 406. This configuration for wireless power transmission 400 can be beneficial whenever smartphone 408 cannot communicate its location by to transmitter 402, for example whenever smartphone 408 runs out of power completely. In addition, smartphone 408 may charge faster because of its proximity to transmitter 402. An even further advantage of this configuration is that if the user decides to remove smartphone 408 (after smartphone 408 has built the minimum charge for establishing communication with transmitter 402) form the surface of transmitter 402, smartphone 408 may still receive power wirelessly through pocket-forming. Thus, the mobility of smartphone 408 may not be compromised.

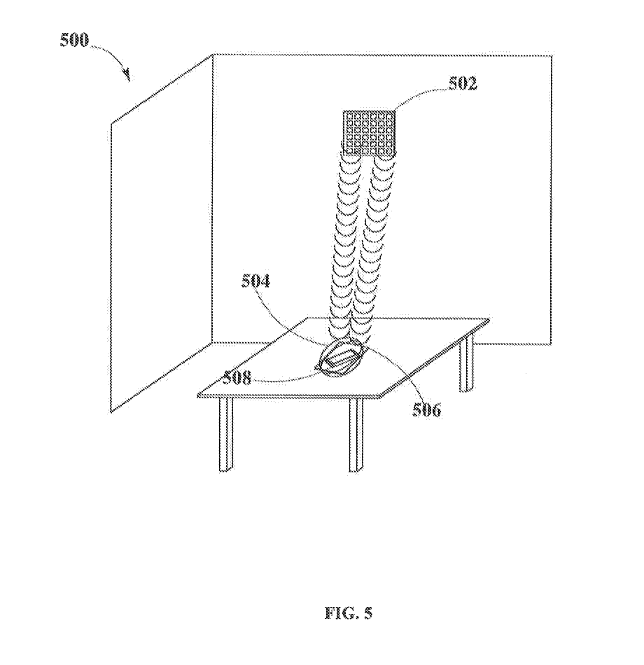

FIG. 5 illustrates an alternative configuration to WPT 400 in the form of a wireless power transmission 500 where a transmitter 502 may create at least one pocket of energy 504 on a portable mat 506. Mat 506 may include at least one receiver and at least one transmitter (not shown) for receiving wireless power from transmitter 502 and re-transmitting such power, through pocket-forming, to a suitable device, for example a smartphone 508 operatively coupled to a receiver (not shown). In some embodiments, mat 506 may communicate to transmitter 502 through short RF signals sent through its antenna elements or via standard communications protocol as described for transmitters and receivers in FIG. 2 and FIG. 3. The foregoing may allow transmitter 502 to easily locate mat 506. The disclosed configuration may be beneficial whenever smartphone 508 may not be able to communicate directly to transmitter 502 as described in FIG. 4 above. This configuration may also be beneficial because mat 506 can be placed virtually in any desirable and easy to reach location. Lastly, transmitter 502 may include a button (not shown) similar to that of transmitter 402 of FIG. 4 which upon activation may produce pocket of energy 504 upon mat 506. The duration of pocket of energy 504 upon mat 506 can be custom defined to suit the needs of various users. An even further advantage of WPT 500 can be that other devices may be placed in the vicinity of mat 506 and can too receive power wirelessly, i.e. electronic devices requiring charge may not even be required to be placed upon mat 506.

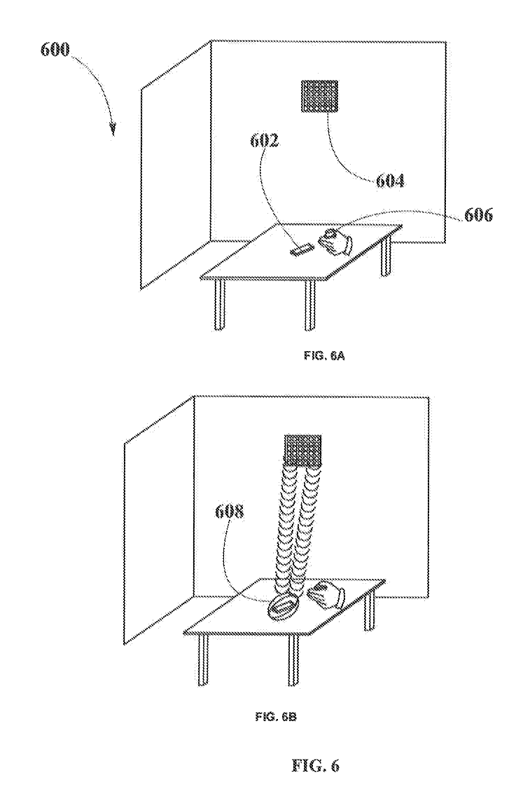

FIG. 6 includes FIG. 6A and FIG. 6B which depict a wireless power transmission 600. Referring first to FIG. 6A, a smartphone 602 operatively coupled to a receiver (not shown) may be out of usable power and may not be able to communicate with a transmitter 604. In this embodiment, a tracer 606 can be used to communicate to transmitter 604 the locations at which power should be delivered. Tracer 606 can include a communications component within it (not shown), as those described for transmitters and receivers in FIG. 2 and FIG. 3, for communicating the foregoing locations to transmitter 604. Such communications component may become active at the user's request. For example, tracer 606 can include an activation button (not shown) which after being pressed may activate the aforementioned communications component. Following this activation, communications component may send a request to transmitter 604 for creating a pocket of energy 608 at the location of tracer 606. In order to charge smartphone 602, users may activate tracer 606 at the same or approximate location of smartphone 602 (FIG. 6B). Upon building the necessary charge, smartphone 602 may optionally communicate its location to transmitter 604 (by its own means) to continue the wireless delivery of power. In other embodiments, pockets of energy 608 can be created at areas or regions of space which may be beneficial or easy to reach for users but where no electronic devices may be present. In this case, electronic devices requiring charge such as smartphone 602 can be moved to the foregoing locations for utilizing pockets of energy 608. The duration of pockets of energy 608, at the absence of electronic devices requiring charge, may be custom defined by users. In some other embodiments, the duration of pockets of energy 608 can be given by the operation of tracer 606, for example, at least one pocket of energy 608 can he generated upon activating tracer 606. Such pocket of energy 608 may remain active until a second press of the activation button of tracer 606.

In the foregoing configuration of wireless power transmission, electronic devices such as smartphone 602 can utilize smaller and cheaper receivers. The foregoing can be accomplished because receivers may not require a communications components on their own for communicating locations to transmitter 604. Rather, tracer 606 can be used to perform such function. In some other embodiments, tracer 606 can take the form of accessories which may connect to electronic via suitable connections such as Universal. Serial Bus (USB). In this case, tracer 606 may become active upon being connected to a device, and may control the totality of the wireless delivery of power.

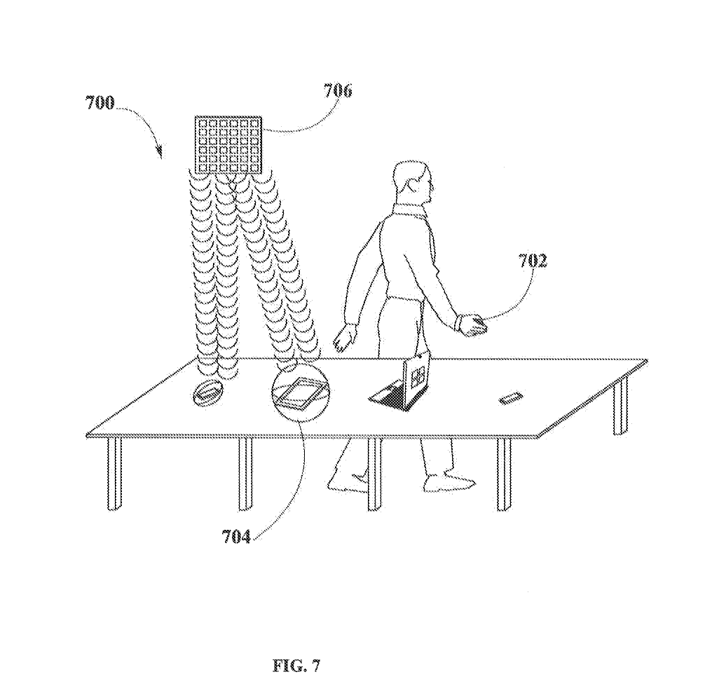

In some embodiments, users may create as many pockets of energy 608 as devices requiring charge as can be seen in FIG. 7 below.

FIG. 7 illustrates a wireless power transmission 700 where a user carrying a tracer 702 may create various pockets of energy 704 in different locations for powering various electronic devices which may include receivers suitable for pocket-forming. Pockets of energy 704 may be formed by a transmitter 706, at the request and locations the user specifies. In addition, once devices build up charge they may optionally communicate their location to transmitter 706 (by their own means) to continue the wireless delivery of power.

While various aspects and embodiments have been disclosed herein, other aspects and embodiments are contemplated. The various aspects and embodiments disclosed herein are for purposes of illustration and are not intended to be limiting, with the true scope and spirit being indicated by the following claims.

Having thus described the invention, I claim:

1. A method for wireless powering of an electronic device, comprising the steps of:
transmitting controlled radio frequency waves from a pocket-forming transmitter to converge pockets of energy in 3-d space; and
capturing the pockets of energy in a receiver to charge or power the electronic device connected to the receiver or in the immediate vicinity of the receiver.

2. The method for wireless powering of an electronic device of claim 1, wherein the transmitter is a portable block configuration that includes an activation button to create at least one pocket of energy on a top surface of the transmitter to power the electronic device placed on the top surface or in proximity to the transmitter when the electronic device is too low on battery power to communicate directly with the transmitter.

3. The method for wireless powering of an electronic device of claim 2, wherein the electronic device is charged to a predetermined level to establish communication with the transmitter for continuing to receive power from the transmitter through pocket-forming when moved away from the proximity of the transmitter.

4. The method for wireless powering of an electronic device of claim 1, wherein the pocket-forming transmitter creates at least one pocket of energy on a portable mat including at least one receiver and at least one transmitter for receiving the wireless power from the transmitter.

5. The method for wireless powering of an electronic device of claim 4, further including the step of retransmitting the power from the mat through pocket-forming to the electronic device.

6. The method for wireless powering of an electronic device of claim 4, wherein the mat communicates to the transmitter through short RF signals sent through antenna elements within the mat.

7. The method for wireless powering of an electronic device of claim 6, wherein the short RF signals are standard wireless communication protocols including Bluetooth, Wi-Fi, ZigBee or FM radio.

8. The method for wireless powering of an electronic device of claim 4, further includes the step of utilizing adaptive pocket-forming to regulate the pockets of energy to power the mat for re-transmitting power to electronic devices on or in proximity to the mat that are low on power and unable to communicate directly with the transmitter to receive a charge.

9. The method for wireless powering of an electronic device of claim 1, further including the step of coupling a receiver of the electronic device out of usable power to communicate with the transmitter through use of a tracer communicating with the transmitter to send pockets of energy to the location of the tracer whereupon the electronic device near the location of the tracer is charged until a predetermined power level is reached allowing direct communication between the electronic device and the transmitter to continue the charging.

10. The method for wireless powering of an electronic device of claim 9, wherein the tracer includes an activation switch to begin communication with the transmitter to continue sending pockets of energy to the location of the tracer for a predetermined amount of time or until the switch is activated again causing the pockets of energy from the transmitter to cease.

11. The method for wireless powering of an electronic device of claim 9, wherein the activation of the tracer provides signals to the transmitter to send a predetermined number of pockets of energy to different locations for powering multiple electronic devices or receivers configured for pocket-forming to power other electronic devices in proximity to the receivers.

12. A wireless powering of an electronic device, comprising:
a transmitter for pocket-forming to send controlled radio frequency waves to converge into pockets of energy in 3-d space; and
a receiver for capturing the pockets of energy to charge or power the electronic device connected to the receiver or in the immediate vicinity of the receiver

13. The wireless powering of an electronic device of claim 12, wherein the transmitter is a portable block configuration that includes an activation button to create at least one pocket of energy on a top surface of the transmitter to power the electronic device placed on the top surface or in proximity to the transmitter when the electronic device is too low on battery power to communicate directly with the transmitter.

14. The wireless powering of an electronic device of claim 12, wherein the electronic device is charged to a predetermined level to establish communication with the transmitter for continuing to receive power from the transmitter through pocket-forming when moved away from the proximity of the transmitter.

15. The wireless powering of an electronic device of claim 12, further includes a portable mat having a transmitter and a receiver for communicating with the transmitter to receive wireless power from the transmitter.

16. The wireless powering of an electronic device of claim 12, wherein the mat re-transmits the power received from the transmitter to power the electronic device placed on the mat or in close proximity thereto until the electronic device reaches a predetermined power level to communicate directly with the transmitter to continue receiving power even after moving away from the mat.

17. The wireless powering of an electronic device of claim 15, wherein the mat communicates with the transmitter through short RF signals over standard wireless communication protocols including Bluetooth, Wi-Fi, ZigBee or FM radio.

18. An apparatus for wireless powering of an electronic device, comprising:
a pocket-forming transmitter for transmitting power RF waves to form pockets of energy to charge the electronic device; and
a receiver connected to the electronic device or in close proximity to the electronic device for capturing the pockets of energy to charge or power the electronic device when the electronic device is unable to communicate with the transmitter due to a low battery power level.

19. The apparatus for wireless powering of an electronic device of claim 18, further including a tracer used to communicate with transmitter to send pockets of energy near the tracer location to charge the electronic device in close proximity to the tracer location When activated.

20. The apparatus for wireless powering of an electronic device of claim 19, wherein the tracer when activated directs a predetermined number of pockets of energy to several locations in the vicinity of the tracer to charge multiple electronic devices at the same time for a predetermined time related to the activation of the tracer.

21. The apparatus for wireless powering of an electronic device of claim 19, further including a mat having both a transmitter and receiver for communicating with the transmitter to receive pockets of energy for re-transmitting power to the electronic device placed on the mat or in close proximity thereto.
